(19) United States
(12) Patent Application Publication
(10) Pub. No.: US 2008/0299477 A1
(43) Pub. Date: Dec. 4, 2008

(54) ELECTROPHOTOGRAPHIC TONER AND METHOD OF MANUFACTURING ELECTROPHOTOGRAPHIC TONER

(75) Inventors: Takao Yamanouchi, Kanagawa (JP); Akio Sato, Tokyo (JP); Shingo Fujimoto, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/044,042

(22) Filed: Mar. 7, 2008

(30) Foreign Application Priority Data
May 28, 2007 (JP) 2007140249

(51) Int. Cl. G03G 9/00; G03G 5/00

(52) U.S. Cl. 430/108.21; 430/137.15

(57) ABSTRACT

An objective is to provide a toner and a method of manufacturing the toner by which a charging amount of toner is kept maintaining to be an appropriate value for a long duration, print images with no fog, together with high density obtained even after heavy-duty printing are obtained, and no contamination within an apparatus caused by toner scattering is generated. Also disclosed is an electrophotographic toner possessing at least a resin and a colorant, wherein the colorant comprises a compound represented by Formula (1) or a lake product of the compound, and the colorant extracted from the electrophotographic toner surface has a colorant surface-exposure amount index of 0.3-0.8.

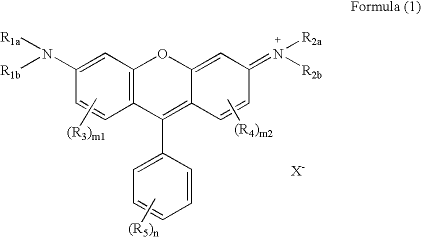

This application claims priority from Japanese Patent Application No. 2007-140249 filed on May 28, 2007, which is incorporated herein to by reference

### TECHNICAL FIELD

The present invention relates to an electrophotographic toner and a method of manufacturing the electrophotographic toner.

### BACKGROUND

A carrier in which a resin is coated on the surface of a magnetic material is conventionally utilized for a two-component developer in order to obtain stable print images exhibiting high quality for a long duration.

However, such the carrier is contaminated by toner fragment which firmly adheres onto the carrier surface, so-called spent generation, and a colorant and external additives added into the toner, via repetitive use of the carrier, whereby charge-providing capability to the toner drops. In the case of printing conducted employing a carrier exhibiting lowered charge-providing capability to the toner, there appears a problem such that fog is generated in print images, and contamination inside an apparatus caused by toner scattering in the apparatus is generated.

It is disclosed toward such the problem that a thermosetting silicone resin coat carrier which is difficult to be contaminated by the spent or such is utilized by making the carrier surface to be at a level of low surface energy.

(Patent Document 1) Japanese Patent O.P.I. Publication No. 5-34990

(Patent Document 1) Japanese Patent O.P.I. Publication No. 8-184997

### SUMMARY

However, the problem in which the carrier surface is contaminated by spent and the like has not yet been solved.

In the case of a full color two-component developer, there is a problem such that charge-providing capability depending on the contamination level of the carrier surface differs since the contamination level differs depending on a colorant employed in preparation of the color toner, whereby the difference in charge-providing capability between colors results during printing.

Specifically in the case of magenta toner, produced is a problem such that variation in charge-providing capability is caused by contamination produced onto the carrier surface of the magenta colorant, and it is difficult to stably provide electrification to the magenta toner. That is why in the past, colorant exposure at the toner surface has been arranged to be inhibited as much as possible, but unstable charge-providing capability generated by carrier contamination caused by components such as external additives and the like other than colorants has remained unsolved.

The present invention has been made on the basis of the above-described situation. It is an object of the present invention to provide a toner and a method of manufacturing the toner by which a charging amount of toner is kept maintaining to be an appropriate value for a long duration, print images with no fog, together with high density obtained even after heavy-duty printing are obtained, and no contamination within an apparatus caused by toner scattering is generated.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is a schematic diagram showing a step in which a hydrochloric acid is added into a dispersion of toner particles to make the colorant dissolved in the dispersion to firmly adhere onto the toner particle surface;

FIG. 2 is a cross-sectional schematic diagram showing an example of an image forming apparatus of the present invention; and

FIG. 3 is a schematic diagram showing a measuring device to measure a charging amount of toner.

### DESCRIPTION OF THE PREFERRED EMBODIMENTS

The above object of the present invention is accomplished by the following structures.

(Structure 1) An electrophotographic toner comprising a resin and a colorant, wherein the colorant comprises a compound represented by Formula (1) or a lake product of the compound, and the colorant extracted from the electrophotographic toner surface has a colorant surface-exposure amount index of 0.3-0.8:

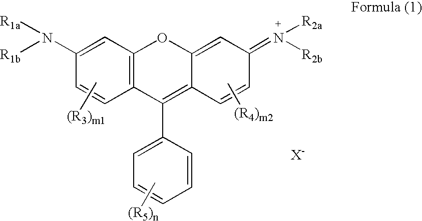

wherein each of R₁ₐ, R_{1b}, R₂ₐ and R_{2b} represents a hydrogen atom, an alkyl group having 1-5 carbon atoms, a fluoroalkyl group having 1-5 carbon atoms or an aryl group; each of R₃ and R₄ represents an alkyl group having 1-5 carbon atoms or a fluoroalkyl group having 1-5 carbon atoms; R₅ represents an alkyl group having 1-5 carbon atoms, a fluoroalkyl group having 1-5 carbon atoms, an alkoxyl group having 1-5 carbon atoms, a halogen atom, a cyano group, a nitro group, a sulfo group, an alkaline earth metal salt of a sulfo group, a higher amine salt of a sulfo group, an N-phenylaminosulfonyl group, a carboxyl group, an alkaline earth metal salt of a carboxyl group, a higher amine salt of a carboxyl group, an N-phenylcarbamoyl group, a ureylene group, an iminodicarbonyl group, an alkoxycarbonyl group, —CONHR₆ where R₆ represents a hydrogen atom, an alkyl group having 1-8 carbon atoms or a phenyl group having 1-8 carbon atoms, —NHCOR₇ where R₇ represents an alkyl group, or —SO₂R₈ where R₈ represents an alkyl group having 1-8 carbon atoms; each of m1 and m2 represents an integer of 1-3; n is an integer of 1-5; and X⁻ represents an anion.

(Structure 2) The electrophotographic toner of Structure 1, wherein the electrophotographic toner is a two-component developer.

(Structure 3) The electrophotographic toner of Structure 1, wherein the compound represented by Formula (1) has a content of 30-100% by weight, based on the total weight of the colorant.

(Structure 4) The electrophotographic toner of Structure 3, wherein the compound has a content of 40-80% by weight, based on the total weight of the colorant.

(Structure 5) A method of manufacturing an electrophotographic toner composed of toner particles each comprising a resin and a colorant, comprising the steps of forming the toner particles via a polymerization method, and diluting 0.056-0.14 parts of a hydrochloric acid with water with respect to 100 parts of the toner particles to conduct a treatment via addition of the hydrochloric acid aqueous solution, wherein the colorant comprises a compound represented by Formula (1) or a lake product of the compound:

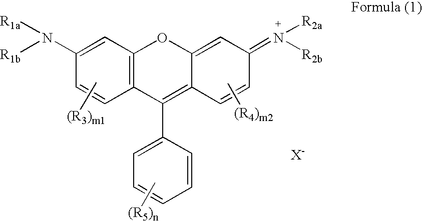

wherein each of R₁ₐ, R_{1b}, R₂ₐ and R_{2b} represents a hydrogen atom, an alkyl group having 1-5 carbon atoms, a fluoroalkyl group having 1-5 carbon atoms or an aryl group; each of R₃ and R₄ represents an alkyl group having 1-5 carbon atoms or a fluoroalkyl group having 1-5 carbon atoms; R₅ represents an alkyl group having 1-5 carbon atoms, a fluoroalkyl group having 1-5 carbon atoms, an alkoxyl group having 1-5 carbon atoms, a halogen atom, a cyano group, a nitro group, a sulfo group, an alkaline earth metal salt of a sulfo group, a higher amine salt of a sulfo group, an N-phenylaminosulfonyl group, a carboxyl group, an alkaline earth metal salt of a carboxyl group, a higher amine salt of a carboxyl group, an N-phenylcarbamoyl group, a ureylene group, an iminodicarbonyl group, an alkoxycarbonyl group, —CONHR₆ where R₆ represents a hydrogen atom, an alkyl group having 1-8 carbon atoms or a phenyl group having 1-8 carbon atoms, —NHCOR₇ where R₇ represents an alkyl group, or —SO₂R₈ where R₈ represents an alkyl group having 1-8 carbon atoms; each of m1 and m2 represents an integer of 1-3; n is an integer of 1-5; and X⁻ represents an anion.

(Structure 6) The method of Structure 5,

wherein the compound represented by Formula (1) has a content of 30-100% by weight, based on the total weight of the colorant.

(Structure 7) The method of Structure 6, wherein the compound represented by Formula (1) has a content of 30-100% by weight, based on the total weight of the colorant.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

There appeared a problem such that charge-providing capability of a carrier dropped, because a resin component having negative electrification relatively to the carrier and external additives having negative electrification were moved to the carrier surface in the case of heavy-duty printing employing a two-component developer having toner and the carrier.

The inventors focused their attention on a property of colorants relatively generating positive electrification, and it was assumed that the foregoing problem could be solved by controlling an exposure amount of the magenta colorant eluted to the toner particle surface.

After considerable effort during intensive studies, the inventors have found out that the amount of colorants having positive electrification moved to the carrier surface is possible to be controlled by utilizing the toner in which a surface-exposure amount of the colorant having positive electrification relatively to the toner is optimized.

It is a feature in the present invention that not only a problem of negative electrification caused by the moved resin component and external additives can be solved, but also a decline of charge-providing capability can be prevented by moving the colorant relatively having positive electrification to the carrier surface.

Since the decline of charge-providing capability has been controlled to be prevented, suitable charge-providing capability can be obtained even after heavy-duty printing, prints with no fog, together with high density can be continuously produced, and generation of contamination inside an apparatus caused by toner scattering has also been prevented.

As a specific method of preparing toner in which the surface-exposure amount index of colorants exhibiting positive electrification relatively is optimized, provided is a method of using an appropriate amount of a hydrochloric acid with respect to the weight of toner particles when toner particles are treated with the hydrochloric acid in a toner washing step, for example, in the case of a wet process.

In this case, in the case of an excessive amount of a hydrochloric acid, carrier charge-providing capability is lowered since the surface-exposure amount of colorants is reduced, and the amount transferred into the carrier is reduced, whereby fog and contamination inside the apparatus are caused. Further, in the case of a very small amount of a hydrochloric acid, there appears a problem such that the charge-providing capability is increased, and developability is lowered, whereby departure from the developing amount control range is caused by a developing bias, since the surface-exposure amount of colorants is increased, and the amount transferred into the carrier is increased. As a result, image density is lowered.

The dissolved colorant of the present invention is present in the aqueous dispersion since it is dissolved at some level in a dispersion of the resulting toner particles.

The colorant dissolved in the dispersion is precipitated by adding a hydrochloric acid in the dispersion, and a partial amount of the colorant firmly adheres onto the toner particle surface.

The toner of the present invention is prepared by controlling the amount of the hydrochloric acid added into the dispersion to adjust the surface-exposure amount of the colorant which firmly adheres onto the toner particle surface within the appropriate range.

In the present invention, the surface-exposure amount of the colorant which firmly adheres onto the toner particle is designated as a colorant surface-exposure amount index obtained via measurement with the following measuring method.

Next, the present invention will be described.

It is a feature in the present invention that the toner of the present invention possessing at least a resin and a colorant is utilized as a two-component developer.

The colorant of the present invention comprises a compound represented by Formula (1) or a lake product of the compound.

In addition, the colorant preferably exhibits strong positive electrification relatively with respect to the toner.

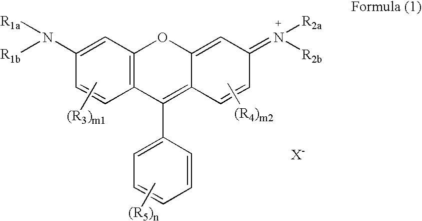

wherein each of R₁ₐ, R_{1b}, R₂ₐ and R_{2b} represents a hydrogen atom, an alkyl group having 1-5 carbon atoms, a fluoroalkyl group having 1-5 carbon atoms or an aryl group; each of R₃ and R₄ represents an alkyl group having 1-5 carbon atoms or a fluoroalkyl group having 1-5 carbon atoms; R₅ represents an alkyl group having 1-5 carbon atoms, a fluoroalkyl group having 1-5 carbon atoms, an alkoxyl group having 1-5 carbon atoms, a halogen atom, a cyano group, a nitro group, a sulfo group, an alkaline earth metal salt of a sulfo group, a higher amine salt of a sulfo group, an N-phenylaminosulfonyl group, a carboxyl group, an alkaline earth metal salt of a carboxyl group, a higher amine salt of a carboxyl group, an N-phenylcarbamoyl group, a ureylene group, an iminodicarbonyl group, an alkoxycarbonyl group, —CONHR₆ where R₆ represents a hydrogen atom, an alkyl group having 1-8 carbon atoms or a phenyl group having 1-8 carbon atoms, —NHCOR₇ where R₇ represents an alkyl group, or —SO₂R₈ where R₈ represents an alkyl group having 1-8 carbon atoms; each of m1 and m2 represents an integer of 1-3; n is an integer of 1-5; and X⁻ represents an anion.

A compound represented by foregoing Formula (1) of the present invention, or a lake product of the foregoing compound will be described.

In Formula (1), an alkyl group having 1-5 carbon atoms represented by R₁ₐ, R_{1b}, R₂ₐ, R_{2b}, R₃ or R₄ may contain an unsubstituted group or a substituent, and examples thereof include a methyl group, an ethyl group, an isopropyl group, a propyl group, a butyl group, a pentyl group and so forth.

It is preferable in this case that one of R₁ₐ and R_{1b} is a hydrogen atom, the other one is an ethyl group, one of R₂ₐ and R_{2b} is a hydrogen atom, and the other one is an ethyl group.

In Formula (1), examples of a fluoroalkyl group having 1-5 carbon atoms represented by R₁ₐ, R_{1b}, R₂ₐ, R_{2b}, R₃ or R₄ include a methyl group, an ethyl group, an isopropyl group, a propyl group, a butyl group, a pentyl group and so forth. The foregoing group may further contain a substituent.

In Formula (1), an alkyl group having 1-5 carbon atoms represented by R₃ or R₄ is preferably a methyl group, and more preferably a methyl group at 3-position in the case of R₃ and at 3′-position in the case of R₄.

In Formula (1), an alkyl group having 1-5 carbon atoms and a fluoroalkyl group having 1-5 carbon atoms represented by R₅ is the same group as represented by R₁ₐ, R_{1b}, R₂ₐ, R_{2b}, R₃ or R₄.

In Formula (1), an alkoxyl group represented by R₅ may contain an unsubstituted group or a substituent, and examples thereof include a methoxy group, an ethoxy group, a propoxy group, an isopropoxy group, a butoxy group and so forth.

In Formula (1), a halogen atom represented by R₅ is a fluorine atom, a chlorine atom, a bromine atom or an iodine atom.

In Formula (1), a higher amine salt of a sulfo group represented by R₅ is amine having at least 4 carbon atoms, and examples thereof include butyl amine, cyclohexylamine, naphthylamine, aniline, phenetidine, toluidine, xylidine and so forth.

In Formula (1), a higher amine salt of a carboxyl group represented by R₅ is amine having at least 4 carbon atoms, and examples thereof include butyl amine, cyclohexylamine, naphthylamine, aniline, phenetidine, toluidine, xylidine and so forth.

In Formula (1), examples of an alkoxycarbonyl group represented by R₅ include a methoxycarbonyl group, an ethoxycarbonyl group, a propoxycarbonyl group, butoxycarbonyl group and so forth. Of these, specifically, a methoxycarbonyl group or an ethoxycarbonyl group is preferably usable, but to be substituted at 2-position is more preferable, and the methoxycarbonyl group or ethoxycarbornyl group substituted at 2-position is particularly preferable.

Regarding Formula (1), in —CONHR₆ group represented by R₅, examples of an alkyl group having 1-8 carbon atoms represented by R₆ include a methyl group, an ethyl group, a propyl group, a pentyl group, a hexyl group, an octyl group and so forth.

Regarding Formula (1), in —NHCOR₇ group represented by R₅, examples of an alkyl group represented by R₇ include a methyl group, an ethyl group, a propyl group, a pentyl group, a hexyl group, an octyl group and so forth.

Regarding Formula (1), in —SO₂R₈ group represented by R₅, examples of an alkyl group having 1-8 carbon atoms represented by R₈ include a methyl group, an ethyl group, a propyl group, a pentyl group, a hexyl group, an octyl group and so forth.

In Formula (1), examples of an anion represented by X⁻ include sulfate, perchlorate, tetraphenylborate, benzenesulfonate, p-toluenesulfonate, a halogen ion and so forth.

A lake product of the compound represented by Formula (1) of the present invention is a lake pigment prepared via salt-formation•insolubilization of the compound represented by foregoing Formula (1) with a complex acid of a phosphotungstic acid, a phosphomolybdic acid or a phosphotungstic•molybdic acid. Of these, a lake pigment prepared employing a phosphotungstic•molybdic acid is preferable.

Herein, a lake pigment prepared with a complex acid of a phosphotungstic•molybdic acid is also called a PTMA lake.

Specific examples of the compound represented by Formula (1) are shown below, but the present invention is not limited thereto.

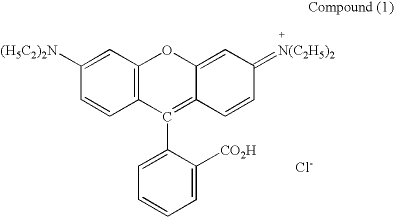

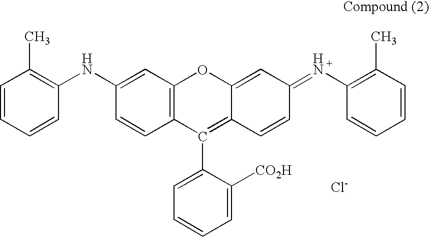

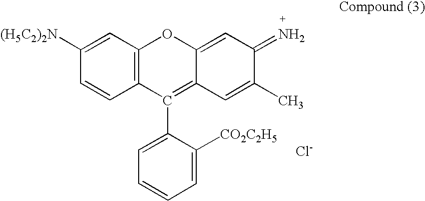

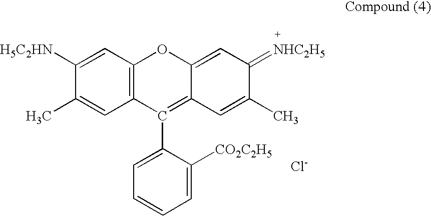

The compound represented by Formula (1) of the present invention can be synthesized similarly to commonly known xanthene rhodamine based compounds such as C.I. Solvent Red 52, C.I. Solvent Red 180 and so forth, and is also commercially available.

Specific examples of the compound represented by Formula (1) include rhodamine B, rhodamine R, rhodamine 3GO and rhodamine dye 6G.

In the present invention, the compound represented by above-described Formula (1) can be used by conducting lake formation. Herein, the lake formation can be conducted by a commonly known method. For example, the compound represented by Formula (1) is dissolved in an acetic acid aqueous solution, and a disodium phosphate aqueous solution, a sodium tungstate aqueous solution and a sodium molybdate aqueous solution are added into the resulting solution to precipitate a pigment obtained via lake formation. After filtrating and washing the lake pigment, drying and pulverization are conducted to utilize the resulting.

The compound represented by foregoing Formula (1) preferably has a content of 30-100% by weight, based on the colorant of the present invention, and more preferably has a content of 40-80% by weight.

Next, the colorant surface-exposure amount index will be described.

The toner of the present invention is one in which the colorant extracted from the toner particle surface has a colorant surface-exposure amount index of 0.3-0.8.

The colorant surface exposure amount index of the present invention means a value obtained by measuring a concentration of the colorant eluted to an aqueous solution from toner.

The colorant surface-exposure amount index can be obtained via the following measuring method.

### Measuring Method:

One gram of toner and 50 g of a surfactant aqueous solution at a liquid temperature of 20° C. {aqueous polyoxyethylene (10) octylphenylether solution having a concentration of 0.2% by weight} are charged into a glass tube of 100 cc to disperse the toner while stirring at 100 rpm for 30 minutes employing a wave rotor. Then, the dispersion is separated to acquire the supernatant solution via treatment at 2000 rpm for 15 minutes employing a centrifuge. Absorbance of this supernatant solution at λ=530 nm (abs value) is measured with a spectrophotometer (U-3310, manufactured by Hitachi Ltd.), and the absorbance is designated as the colorant surface-exposure amount index. In addition, the maximum value of the colorant surface-exposure amount index is 1.

Next, a method of manufacturing toner will be described.

As a method of manufacturing the toner, specifically described will be an example of a mini-emulsion polymerization coagulation method.

The steps of manufacturing the toner are as follows.

(1) Solution/dispersion step in which toner particle constituent materials such as a releasing agent, a colorant and optionally, a charge controlling agent are dissolved or dispersed in a polymerizable monomer to form a binding resin to obtain a polymerizable monomer solution.

(2) Polymerization step in which the polymerizable monomer solution is dispersed in the form of oil-droplets dispersed in an aqueous medium and polymerized through mini-emulsion to prepare a dispersion of binding resin particles.

(3) Coagulation/fusion step in which the binding resin particles are allowed to be salted out, coagulated and fused to form coalesced particles.

(4) Ripening step in which the coagulated particles are thermally ripened to control the particle shape to obtain a dispersion of toner particles.

(5) Cooling step in which the dispersion of toner particles is cooled.

(6) Hydrochloric acid treatment step in which a hydrochloric acid is added into the cooled dispersion of toner particles to make the colorant in the dispersion to firmly adhere onto the toner particle surface.

(7) Filtration/washing step in which toner particles are separated through solid/liquid separation from the dispersion of toner particles into which the hydrochloric acid is added to remove the hydrochloric acid, surfactants and the like from the toner particles.

(8) Drying step in which the washed toner particles are dried.

(9) Step of adding external additives to the dried toner particles.

Each of the steps is further detailed below.

### (1) Solution/Dispersion:

This step comprises dissolving or dispersing toner particle constituent materials such as releasing agents and colorants in a polymerizable monomer to form a polymerizable monomer solution.

The releasing agents are added in such an amount that the content of the releasing agents falls within the range described earlier.

The polymerizable monomer solution may be added with an oil-soluble polymerization initiator and/or other oil-soluble components.

### (2) Polymerization:

In one suitable embodiment of the polymerization step, the foregoing polymerizable monomer solution is added to an aqueous medium containing a surfactant at a concentration lower than the critical micelle concentration and mechanical energy is applied thereto to form oil-droplets, subsequently, polymerization is performed in the interior of the oil-droplets by radicals produced from a water-soluble polymerization initiator. Resin particles as nucleus particles may be added to the aqueous medium in advance.

Binding resin particles containing reducing agents and a binding resin are obtained in the polymerization step. The obtained binding resin particles may or may not be colored. The colored binding resin particles can be obtained by subjecting a monomer composition containing a colorant to polymerization. In cases when using non-colored binding resin particles, a dispersion of colorant particles is added to a dispersion of binding resin particles, and the colorant particles and the binding resin particles are coagulated to obtain toner particles.

The aqueous medium refers to a medium that is composed mainly of water (at least 50% by weight). A component other than water is a water-soluble organic solvent. Examples thereof include methanol, ethanol, isopropanol, butanol, acetone, methyl ethyl ketone and tetrahydrofuran. Of these solvents, alcoholic organic solvents such as methanol, ethanol, isopropanol and butanol are specifically preferred.

Dispersing machines to perform oil-droplet dispersion by using mechanical energy are not specifically limited and examples thereof include CLEAR MIX (produced by M Technique Co., Ltd.) equipped with a high-speed rotatable rotor, an ultrasonic homogenizer, a mechanical homogenizer, a Manton-Gaulin homogenizer and a pressure homogenizer. The dispersed particle size is preferably within the range of 10-1000 nm, and more preferably 30-300 nm.

### (3) Coagulation/Fusion:

In the coagulation/fusion step, in cases when the binding resin particles are non-colored, a dispersion of colorant particles is added to the dispersion of binding resin particles, obtained in the foregoing polymerization step, and allowing the binding resin particles to be salted out, coagulated and fused with the colorant particles. In the course of the coagulation/fusion step, binding resin particles differing in resin composition may further be added to perform coagulation.

In the coagulation/fusion step, particles of internal additives such as a charge-controlling agent may be coagulated together with binding resin particles and colorant particles.

Coagulation/fusion is performed preferably in the following manner. To an aqueous medium including binding resin particle and colorant particles, a salting-out agent composed of alkali metal salts and/or alkaline earth metal salts is added as a coagulant at a concentration of more than the critical coagulation concentration and then heated at a temperature higher than the glass transition point of the binding resin particles and also higher than the melting peak temperature of a releasing agent used therein to perform salting-out concurrently with coagulation/fusion.

In the coagulation/fusion step, it is necessary to perform prompt rise in temperature by heating and the temperature raising rate is preferably not less than 1° C./min. The upper limit of the temperature raising rate is not specifically limited but is preferably not more than 15° C./min in terms of inhibiting formation of coarse particles due to a rapid progress of salting-out, coagulation and fusion.

After a dispersion of binding resin particles and colorant particles reaches a temperature higher than the glass transition point of the binding resin particles and also higher than the melting peak temperature of a releasing agent, it is essential to maintain that temperature of the dispersion over a given time to allow salting-out, coagulation and fusion. Thereby, growth of toner particles (coagulation of binding resin particles and colorant particles) and fusion (dissipation of interfaces between particles) effectively proceed, leading to enhanced durability of the toner.

A dispersion of colorant particles can be prepared by dispersing colorant particles in an aqueous medium. Dispersing colorant particle is performed at a surfactant concentration in water higher than the critical micelle concentration (CMC). Dispersing machines used for dispersing colorant particles are not specifically limited but preferred examples thereof include pressure dispersing machines such as an ultrasonic disperser, a mechanical homogenizer, a Manton-Gaulin homomixer or a pressure homogenizer, and a medium type dispersing machines such as a sand grinder, a Gettsman mill or a diamond fine mill.

The colorant particles may be those which have been subjected to surface modification treatments. Surface modification of the colorant particles is affected, for example, in the following manner. A colorant is dispersed in a solvent, and a surface-modifying agent is added and allowed to react with heating After completion of the reaction, the colorant is filtered off, washed with the same solvent and dried to produce a surface-modified colorant.

### (4) Ripening:

Ripening is performed preferably by using thermal energy (heating).

Specifically, a system including coagulated particles is stirred with heating, while controlling the heating temperature, a stirring speed and heating rate until the shape of toner particles reaches the intended average circularity.

In the ripening step, the toner particles obtained above may be used as core particles and binding resin particles are further adhered and fused onto the core particles to form a core/shell structure. In that case, the glass transition point of binding resin particle constituting the shell layer is preferably higher by at least 20° C. than that of binding resin particles constituting the core particles.

When binding resin particles used in the coagulation/fusion step are composed of a resin made from a polymerizable monomer containing an ionically dissociative group (hydrophilic resin) and a resin made from a polymerizable monomer containing no ionically dissociative group (hydrophobic resin), toner particles having a core/shell structure may be formed by disposing the hydrophilic resin on the surface side of the coagulated particle and the hydrophobic resin in the inside of the coagulated particle.

### (5) Cooling:

This step refers to a stage that subjects a dispersion of the foregoing toner particles to a cooling treatment (rapid cooling). Cooling is performed at a cooling rate of 1 to 20° C./min. The cooling treatment is not specifically limited and examples thereof include a method in which a refrigerant is introduced from the exterior of the reaction vessel to perform cooling and a method in which chilled water is directly supplied to the reaction system to perform cooling.

### (6) Hydrochloric Acid Treatment:

In the hydrochloric acid treatment step, a hydrochloric acid aqueous solution is added into cooled toner particles while stirring, and colorants dissolved in the dispersion or drifting colorant particles firmly adhere onto the toner particle surface.

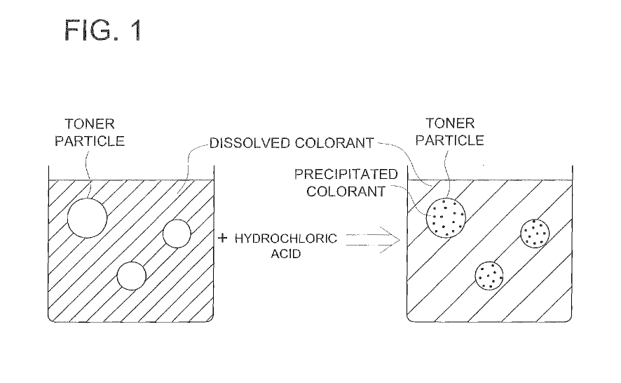

FIG. 1 is a schematic diagram showing a step in which a hydrochloric acid is added into a dispersion of toner particles to make the colorant dissolved in the dispersion to firmly adhere onto the toner particle surface.

To be more precise, the dispersion of toner particles is charged into a tank equipped with stirring blades, and a hydrochloric acid is added while evenly stirring the dispersion of toner particles with the stirring blades. In addition, the rotation speed of stirring blades is desired to be a rotation speed capable of maintaining a situation where neither sedimentation nor foaming is generated.

Utilized is a process in which a hydrochloric acid aqueous solution diluted with water so as to be 0.056-0.14 parts by weight of hydrochloric acid with respect to 100 parts by weight of toner (8-20 parts by weight of hydrochloric acid having a concentration of 0.7% by weight, for example) is added via control of a flow monitor or loadcell measurement.

### (7) Filtration/Washing:

In the filtration and washing step, a solid-liquid separation treatment of separating toner particles from a toner particle dispersion is conducted, then cooled to the prescribed temperature in the foregoing step and a washing treatment for removing adherent material such as a surfactant or salting-out agent, and alkaline chemicals employed in the ripening step from a separated toner particles (aggregate in a cake form) is conducted.

In addition, the filtration/washing treatment is preferably conducted immediately after the hydrochloric acid treatment in order to prevent change in state after the hydrochloric acid treatment.

In this step, washing is conducted until the filtrate reaches a conductivity of 10 μS/cm. A filtration treatment is conducted, for example, by a centrifugal separation, filtration under reduced pressure using a Nutsche funnel or filtration using a filter press, but the treatment is not specifically limited.

### (8) Drying:

In this step, the washed toner cake is subjected to a drying treatment to obtain dried colored particles. Drying machines usable in this step include, for example, a spray dryer, a vacuum freeze-drying machine, or a vacuum dryer. Preferably used are a standing plate type dryer, a movable plate type dryer, a fluidized-bed dryer, a rotary dryer or a stirring dryer. The moisture content of the dried toner particles is preferably not more than 5% by weight, and more preferably not more than 2%. When toner particles that were subjected to a drying treatment are aggregated via a weak attractive force between particles, the aggregate may be subjected to a pulverization treatment. Pulverization can be conducted using a mechanical pulverizing device such as a jet mill, Henschel mixer, coffee mill or food processor.

### (9) External Additive Addition Treatment:

In this step, the dried colored particles are optionally mixed with external additives to prepare a toner. There are usable mechanical mixers such as a Henschel mixer and a coffee mill.

Next, the material constituting toner will be described.

### (Binding Resin)

As a resin constituting toner of the present invention, one exhibiting negative electrification relatively with respect to the toner is preferably employed.

In toner particles manufactured by a suspension polymerization, a mini-emulsion polymerization coagulation method or an emulsion polymerization coagulation method, examples of a polymerizable monomer to obtain a resin forming the toner particles include styrene and derivatives thereof such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene; methacrylic acid ester derivatives such as methyl methacrylate, ethyl methacrylate, n-butyl methacrylate, isopropyl methacrylate, isobutyl methacrylate, t-butyl methacrylate, n-octyl methacrylate, 2-ethyl methacrylate, stearyl methacrylate, lauryl methacrylate, phenyl methacrylate, diethylaminoethyl methacrylate, dimethylaminoethyl methacrylate; acrylic acid esters and derivatives thereof such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, phenyl acrylate, and the like; olefins such as ethylene, propylene, isobutylene, and the like; halogen based vinyls such as vinyl chloride, vinylidene chloride, vinyl bromide, vinyl fluoride, and vinylidene fluoride; vinyl esters such as vinyl propionate, vinyl acetate, and vinyl benzoate; vinyl ethers such as vinyl methyl ether and vinyl ethyl ether; vinyl ketones such as vinyl methyl ketone, vinyl ethyl ketone, and vinyl hexyl ketone; N-vinyl compounds such as N-vinylcarbazole, N-vinylindole, and N-vinylpyrrolidone; vinyl compounds such as vinylnaphthalene and vinylpyridine; as well as derivatives of acrylic acid or methacrylic acid such as acrylonitrile, methacrylonitrile, and acryl amide. These vinyl based monomers may be employed singly or in combination.

Further, preferably employed as polymerizable monomers, which constitute the toner of the present invention, are those having ionic dissociative groups in combination, and include, for instance, those having substituents such as a carboxyl group, a sulfonic acid group, and a phosphoric acid group, as the constituting groups of the monomers. Specifically listed are acrylic acid, methacrylic acid, maleic acid, itaconic acid, cinnamic acid, fumaric acid, maleic acid monoalkyl ester, itaconic acid monoalkyl ester, styrenesulfonic acid, allylsulfosuccinic acid, 2-acrylamido-2-methylpropanesulfonic acid, acid phosphoxyethyl methacrylate, 3-chloro-2-acid phosphoxyethyl methacrylate, and 3-chloro-2-acid phosphoxypropyl methacrylate.

Further, it is possible to prepare resins having a cross-linking structure, employing polyfunctional vinyls such as divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol methacrylate, and neopentyl glycol diacrylate.

### (Surfactant)

In manufacturing the toner particles of the present invention by the suspension polymerization method, a mini-emulsion polymerization coagulation method or emulsion polymerization coagulation method, surfactants used for obtaining a binding resin are not specifically limited but ionic surfactants described below are suitable. Such ionic surfactants include sulfates (e.g., sodium dodecylbenzenesulfate, sodium arylalkylpolyethersulfonate, sodium 3,3-disulfondisphenylurea-4,4-diazo-bis-amino-8-naphthol-6-sulfonate, ortho-carboxybenzene-azo-dimethylaniline, sodium 2,2,5,5-tetramethyl-triphenylmethane-4,4-diazo-bis-β-naphthol-6-sulfonate) and carboxylates (e.g., sodium oleate, sodium laurate, sodium caprate, sodium caprylate, sodium caproate, potassium stearate, calcium oleate). Nonionic surfactants are also usable. Examples thereof include polyethylene oxide, polypropylene oxide, a combination of polypropylene oxide and polyethylene oxide, an ester of polyethylene glycol and a higher fatty acid, alkylphenol polyethylene oxide, an ester of polypropylene oxide and a higher fatty acid, and sorbitan ester. These surfactants are used as an emulsifying agent when manufacturing the toner by an emulsion polymerization method but may also be used in other processes or for other purposes.

### (Polymerization Initiator)

In preparation of the toner particles of the present invention by the suspension polymerization method, a mini-emulsion polymerization coagulation method or an emulsion polymerization coagulation method, binding resin can be obtained through polymerization by using radical polymerization initiators.

Specifically, oil-soluble radical polymerization initiators are usable in suspension polymerization and examples of an oil-soluble polymerization initiator include azo- or diazo-type polymerization initiators, e.g., 2,2′-azobis-(2,4-dimethylvaleronitrile), 2,2′-azobisisobutylonitrile, 1,1′-azobis(cyclohexane-1-carbonitrile), 2,2′-azobis-4-methoxy-2,4-dimethylvaleronitrile, azobisisobutylonitrile; peroxide type polymerization initiators, e.g., benzoyl peroxide, methyl ethyl ketone peroxide, diisopropylperoxycarbonate, cumene hydroperoxide, t-butyl hyroperoxide, di-t-butyl peroxidedicumyl peroxide, 2,4-dichlorobenzoyl peroxide, lauroyl peroxide, 2,2-bis-(4,4-t-butylperoxycyclohexyl)-propane, tris-(t-butylperoxy)triazine; and polymeric initiators having a side-chain of peroxide.

Water-soluble radical polymerization initiators are usable in an emulsion polymerization method or emulsion polymerization coagulation method. Examples of a water-soluble polymerization initiator include persulfates such as potassium persulfate and ammonium persulfate; azobisaminodipropane acetic acid salt, azobiscyanovaleric acid and its salt, and hydrogen peroxide.

### (Chain-Transfer Agent)

In preparation of the toner particles of the present invention by the suspension polymerization method, a mini-emulsion polymerization coagulation method or an emulsion polymerization coagulation method, generally used chain-transfer agents are usable for the purpose of controlling the molecular weight of a binding resin.

Chain-transfer agents are not specifically limited but examples thereof include mercaptans such as n-octylmercaptan, n-decylmercaptane and tert-dodecylmercaptan; n-octyl-3-mercaptopropionic acid ester, terpinolene, carbon tetrabromide, carbon and α-methylstyrene dimmer.

### (Releasing Agent)

Waxes usable in the toner of the present invention are those known in the art. Examples thereof include polyolefin wax such as polyethylene wax and polypropylene wax; long chain hydrocarbon wax such as paraffin wax and sasol wax; dialkylketone type wax such as distearylketone; ester type wax such as carnauba wax, montan wax, trimethylolpropane tribehenate, pentaerythritol tetramyristate, pentaerythritol tetrabehenate, pentaerythritol diacetate dibehenate, glycerin tribehenate, 1,18-octadecanediol distearate, trimellitic acid tristarate, and distearyl meleate, and amide type wax such as ethylenediamine dibehenylamide and trimellitic acid tristearylamide.

The melting point of wax usable in the present invention is preferably 40-160° C., more preferably 50-120° C., and still more preferably 60-90° C. A melting point falling within the foregoing range ensures heat resistant stability of toners, and can achieve stable toner image formation without causing cold offsetting even when fixed at a relatively low temperature. The wax content of the toner is preferably in the range of 1-30% by weight, and more preferably 5-20% by weight.

Next, the polymerization initiator, the chain transfer agent and the surfactant will be described.

### (Colorant)

In the present invention, the following colorants can be used in combination in order to prepare color toners.

Commonly known inorganic or organic colorants can be utilized as the colorant used in combination. Specific colorants are listed below.

Examples of black colorants include carbon black such as Furnace Black, Channel Black, Acetylene Black, Thermal Black and Lamp Black and magnetic powder such as magnetite and ferrite.

Magenta or red colorants can also be used by mixing a compound represented by foregoing Formula (1) with the following colorant.

Examples of magenta or red colorants include C.I. Pigment Red 2, C.I. Pigment Red 3, C.I. Pigment Red 5, C.I. Pigment Red 16, C.I. Pigment Red 48, C.I. Pigment Red 53, C.I. Pigment Red 57, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of orange or yellow colorants include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 74, C.I. Pigment Yellow 93, C.I. Pigment Yellow 94, C.I. and Pigment Yellow 138.

Examples of green or cyan colorants include C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Blue 62, C.I. Pigment Blue 66 and C.I. Pigment Green 7.

The above-described colorants can be used singly or in combination with at least two kinds.

The colorant has an addition amount of 1-30% by weight, and preferably has an addition amount of 2-20% by weight, based on the total weight of toner.

Surface-modified colorants are also usable as the colorant. Commonly known surface modifiers are usable and preferred examples thereof include a silane coupling agent, a titanium coupling agent and an aluminum coupling agent.

### (Coagulant)

Coagulants usable in manufacturing the toner particles of the present invention by a mini-emulsion polymerization coagulation method or an emulsion polymerization coagulation method include, for example, alkali metal salts and alkaline earth metal salts. Alkali metals constituting a coagulant include, for example, lithium, sodium and potassium; alkaline earth metals constituting a coagulant include, for example, magnesium, calcium, strontium and barium. Of the foregoing, potassium, sodium, magnesium, calcium and barium are preferred. Counter-ions for the alkali metal or the alkaline earth metal (anion constituting a salt) include, for example, chloride ion, bromide ion, iodide ion, carbonate ion and sulfate ion.

### (Charge Controlling Agent)

The toner particles of the present invention may optionally contain a charge controlling agent. Charge controlling agents usable in the present invention include various compound known in the art.

### (Particle Diameter of Toner Particle)

The toner particles of the present invention preferably have a number-based median particle diameter (D₅₀) of 3-8 μm. In manufacturing toner particles by the polymerization methods described earlier, the particle diameter can be controlled by a coagulant concentration, the addition amount of organic solvents, a fusion time and polymer composition.

A number-based median particle diameter (D₅₀) falling within the range of 3-8 μm not only achieves reproduction of fine lines and enhanced image quality of photographic images but can also reduce toner consumption, compared to the use of a toner of a larger particle diameter.

### (Average Circularity of Toner Particle)

As to the toner of the present invention, each toner particle constituting this toner preferably has an average circularity represented by the following equation (3) being 0.930-1.000, and more preferably has an average circularity of 0.950-0.995.

Circularity={(circumference of a circle having an area equivalent to the projected area of a particle)/(a circumference of the projected particle)} Equation (3):

### (External Additive)

To improve flowability or electrification or to enhance cleaning capability, so-called external additives may be added into the toner of the present invention.

External additives used in the present invention are those exhibiting negative electrification relatively with respect to toner. These external additives are not specifically limited and various inorganic particles, organic particles and lubricants are usable as the external additive.

Inorganic oxide particles of silica, titania, alumina and the like are preferably used for inorganic particles. The inorganic particles may be surface-treated preferably by using a silane coupling agent, titanium coupling agent and the like to enhance hydrophobicity. Spherical organic particles having an average primary particle size of 10 to 2000 nm are also usable. Polystyrene, poly(methyl methacrylate), styrene-methyl methacrylate copolymer and the like are usable as organic particles.

These external additives are incorporated to the toner preferably in an amount of 0.1-0.5% by weight, and more preferably 0.5-4.0% by weight. External additives may be incorporated singly or in combination.

### (Developer)

The toner of the present invention may be used as a magnetic or nonmagnetic single-component developer or as a two-component developer mixed with a carrier. To be more concrete, in cases when the toner is used as a single-component developer, a nonmagnetic single-component developer and a magnetic single-component developer which contains magnetic particles of 0.1-0.5 μm in the toner are cited and both are usable. In cases when the toner is used as a two-component developer, magnetic particles composed of metals such as iron, ferrite or magnetite, or alloys of the foregoing metals and aluminum or lead are usable as a carrier, and of these, ferrite particles are specifically preferred.

Coating resins used for the coat carrier are preferably those exhibiting positive electrification relatively with respect to toner, and examples thereof include olefin based resin, styrene based resin, styrene-acryl based resin, silicone based resin, ester resin and fluorine-containing polymer resin. Resins used for the resin dispersion type carrier are not specifically limited and commonly known ones are usable, such as styrene-acryl based resin, polyester resin, fluororesin and phenol resin.

A coat carrier coated with styrene-acryl based resin is cited as a preferred carrier in terms of preventing external additives from being released and durability.

The volume-based median diameter (D₅₀) of carrier particles is preferably 20-100 μm, and more preferably 25-80 μm. The volume-based median diameter (D₅₀) of the carrier particles can be determined using a laser diffraction type particle size distribution measurement apparatus equipped with a wet disperser (HELOS, produced by SYMPATEC Corp.).

Next, an image forming apparatus will be described.

It is preferred that the image forming apparatus of the present invention comprises a charging device to charge the photoreceptor surface; an exposure device to form an electrostatic latent image by exposing the charged photoreceptor to light; a developing device to form a toner image by developing the electrostatic latent image on the photoreceptor with the toner; a primary transfer device to transfer the toner image on the photoreceptor onto an intermediate transfer body; a transfer device to transfer the toner image transferred onto the intermediate transfer body to a transfer material; and a device of thermally fixing the toner on the transfer material to the transfer material employing a contact-heating fixing device equipped with a heat belt and a pressure belt.

In addition to the above-described devices, the image forming apparatus may further possess a cleaning device to clean the intermediate transfer body and a coating device to coat a lubricant on the photoreceptor surface.

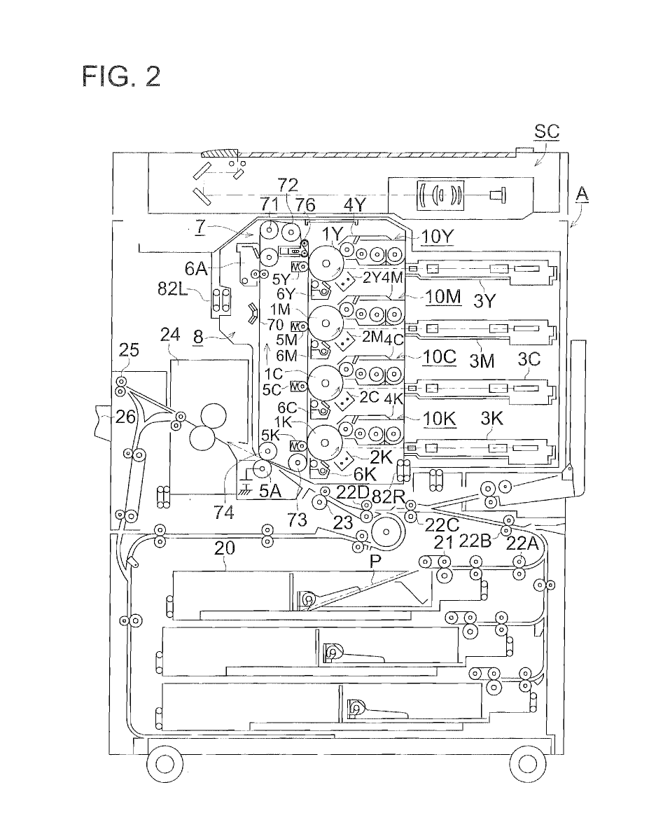

FIG. 2 is a cross-sectional schematic diagram showing an example of an image forming apparatus of the present invention.

In FIG. 2, 1Y, 1M, 1C and 1K each represent a photoreceptor, 4Y, 4M, 4C and 4K each represent a developing device, 5Y, 5M, 5C and 5K each represent a primary transfer roll as a primary transfer device, 5A represents a secondary transfer roll as a secondary transfer device, 6Y, 6M, 6C and 6K each represent a cleaning device, 7 represents an intermediate transfer body unit, 24 represents a heat roll type fixing device, and 70 represents an intermediate transfer body.

This image forming apparatus called a tandem type color image forming apparatus comprises a plurality of image forming sections 10Y, 10M, 10C, and 10K, endless-belt-shaped intermediate transfer body unit 7, endless-belt-shaped sheet convey device 21 to convey recording member P, and heat roll type fixing device 24 as fixing device 24 Document image reading device SC is placed on main body A of the image forming apparatus.

Image forming section 10Y forming the yellow image as one toner image out of different colors formed on each photoreceptor comprises drum-shaped photoreceptor 1Y as the first photoreceptor, charging device 2Y placed around the photoreceptor 1Y, exposure device 3Y, developing device 4Y, primary transfer roll 5Y as a primary transfer device, and cleaning device 6Y. Image forming section 10M forming the magenta image as one toner image of another different color comprises drum-shaped photoreceptor 1M as the first photoreceptor, charging device 2M placed around the photoreceptor 1M, exposure device 3M, developing device 4M, primary transfer roll 5M as a primary transfer device, and cleaning device 6M. The image forming section 10C forming the cyan image further as one toner image of another different color comprises drum-shaped photoreceptor 1C as the first photoreceptor, charging device 2C placed around the photoreceptor 1C, exposure device 3C, developing device 4C, primary transfer roll 5C as a primary transfer device, and cleaning device 6C. Image forming section 10K forming the black image further as one toner image of another different color comprises drum-shaped photoreceptor 1K as the first photoreceptor, charging device 2K placed around the photoreceptor 1K, exposure device 3K, developing device 4K, primary transfer roll 5K as a primary transfer device, and cleaning device 6K.

Endless-belt-shaped intermediate transfer body unit 7 is windingly wound with a plurality of rolls, and has endless-belt-shaped intermediate transfer body 70 as an intermediate transfer endless-belt-shaped second image carrier arranged to be supported and capable of rotation.

Color images formed by image forming sections 10Y, 10M, 10C, and 10K each are sequentially transferred onto rotating endless-belt-shaped intermediate transfer body 70 by primary transfer rolls 5Y, 5M, 5C, and 5K so that a composite color image is formed. Recording member P of a sheet as a transfer material received in sheet feeding cassette 20 is fed by sheet feeding device 21, conveyed to secondary transfer roll 5A as a secondary transfer device through a plurality of intermediate rolls 22A, 22B, 22C, 22D, and registration roll 23, and then, the color image is secondarily transferred onto recording member P all at once. Recording member P on which the color image has been transferred is fixed by heat roll type fixing device 24, sandwiched by paper-ejection roll 25, and mounted on paper-ejection tray 26 outside the machine.

On the other hand, after the color image has been transferred onto recording member P by secondary transfer roll 5A, residual toner is removed from endless-belt-shaped intermediate transfer body 70, from which recording member P has self-striped, with cleaning device 6A.

During image forming processing, primary transfer roll 5K is constantly pressed against photoreceptor 1K. Other primary transfer rolls 5Y, 5M, and 5C are pressed against photoreceptors 1Y, 1M, and 1C, respectively only during color image formation.

Secondary transfer roll 5A is pressed against endless-belt-shaped intermediate transfer body 70 only when recording member P passes through here and the secondary transfer is carried out.

Enclosure 8 is capable of being drawn out of apparatus main body A guided by supporting rails 82L and 82R.

Enclosure 8 comprises image forming sections 10Y, 10M, 10C, 10K and endless-belt-shaped intermediate transfer body unit 7.

Image forming sections 10Y, 10M, 10C, and 10K are disposed vertically in alignment. Endless-belt-shaped intermediate transfer body unit 7 is disposed on the left side, in the figure, of photoreceptors 1Y, 1M, 1C, and 1K. Endless-belt-shaped intermediate transfer body unit 7 comprises endless-belt-shaped intermediate transfer body capable of rotation 70 by winding rolls 71, 72, 73, 74 and 76, primary transfer rolls 5Y, 5M, 5C and 5K, and cleaning device 6A.

Image forming sections 10Y, 10M, 10C, and 10K, and endless-belt-shaped intermediate transfer body unit 7 are pulled out of main body A in an integrated manner via pulling-out operation of enclosure 8.

In this way, toner images are formed on photoreceptors 1Y, 1M, 1C and 1K via electrification, exposure and development, toner images of each color are superimposed on endless-belt-shaped intermediate transfer body 70 to be transferred into transfer material P all at once, and to be subsequently fixed via applied pressure and heating by heat roll type fixing device 24. As to photoreceptors 1Y, 1M, 1C and 1K after transferring toner images into recording member P, toner remaining on the photoreceptors is cleaned during transfer employing cleaning device 6A, and a cycle of the above-described electrification, exposure and development is subsequently carried out to conduct the next image formation.

### EXAMPLE

Next, the present invention will be explained employing examples, but the present invention is not limited thereto

### <<Preparation of Toner>>

Toner was prepared in the following procedure.

### <Preparation of Toner>

Compounds (1)-(3) and Pigment Red 48;3 were arranged to be prepared as colorants.

### <Preparation of Toner 1>

### [Preparation of Resin Particle Dispersion A]

### (The 1^{st} Step Polymerization)

A solution in which 8 parts by weight of dodecyl sodium sulfate were dissolved in 3000 parts by weight of ion-exchange water was charged in a reaction vessel fitted with a stirring device, a temperature sensor, a cooling tube and a nitrogen introducing device, and the inner temperature was raised up to 80° C. while stirring at a stirring speed of 230 rpm under the nitrogen flow. After the raised temperature, a solution in which 10 parts by weight of potassium persulfate were dissolved in 200 parts by weight of ion-exchange water was added into the system, and the liquid temperature was again set to 80° C. to drip a polymerizable monomer solution containing 480 parts by weight of styrene, 250 parts by weight of n-butylacrylate, 68.0 parts by weight of methacrylic acid and 16.0 parts by weight of n-octyl-3-mercaptopropionate, spending one hour. Subsequently, the system was heated at 80° C. for 2 hours while stirring, and polymerization was conducted to prepare resin particle dispersion (1H) containing resin particle (1h).

### (The 2^{nd} Step Polymerization)

A solution in which 7 parts by weight of polyoxyethylene-2-dodecyl ether sodium sulfate were dissolved in 800 parts by weight of ion-exchange water was charged in a reaction vessel fitted with a stirring device, a temperature sensor, a cooling tube and a nitrogen introducing device. After heating the system to 98° C., a polymerizable monomer solution in which 245 parts by weight of styrene, 120 parts by weight of n-butylacrylate, 1.5 parts by weight of n-octyl-3-mercaptopropionate, 64 parts by weight of releasing agent (pentaerythritol tetrabehenate), together with 260 parts by weight of the above-described resin particle dispersion (1H) were dissolved at 90° C. was added into the system, and mixed while dispersing for one hour employing a mechanical homogenizer CLEARMIX (manufactured by M•Technique Co., Ltd.) having a circulation path to prepare a dispersion containing emulsified particles (oil droplets).

Next, an initiator solution in which 6 parts by weight of potassium persulfate were dissolved in 200 parts by weight of ion-exchange water was added into this dispersion, and this system was polymerized at 82° C. while stirring for one hour to prepare resin particle dispersion (1HM) containing resin particle (1hm).

### (The 3^{rd} Step Polymerization)

A solution in which 11 parts by weight of potassium persulfate were dissolved in 400 parts by weight of ion-exchange water was added into the above-described resin particle dispersion (1HM), and a polymerizable monomer solution containing 435 parts by weight of styrene, 130 parts by weight of n-butylacrylate, 33 parts by weight of methacrylic acid and 8 parts by weight of n-octyl-3-mercaptopropionate was dripped at 82° C., spending one hour. After completion of dripping, a polymerization treatment was conducted while heating and stirring for two hours, and the system was subsequently cooled down to 28° C. to obtain resin particle dispersion A containing resin particle a. When the particle diameter of resin particles in the resulting resin particle dispersion A was measured employing an electrophoretic light scattering photometer ELS-800 (manufactured by Otsuka Electronics Co., Ltd.), it was 150 nm in volume-based median diameter. Further, the measured glass transition temperature of the resin particles was 45° C.

### [Preparation of Colorant Particle Dispersion Q]

While stirring, 200 parts by weight of compound (1) and 200 parts by weight of Pigment Red 48;3 were gradually added into a solution in which 90 parts by weight of dodecyl sodium sulfate were dissolved in 1600 parts by weight of ion-exchange water, and a dispersion treatment was subsequently conducted employing a mechanical homogenizer CLEARMIX (manufactured by M•Technique Co., Ltd.) to prepare colorant particle dispersion Q. When the particle diameter of colorant particles in the resulting colorant particle dispersion Q was measured employing an electrophoretic light scattering photometer ELS-800 (manufactured by Otsuka Electronics Co., Ltd.), it was 110 nm in volume-based median diameter

### [Preparation of Toner Particle 1]

A solution in which 300 parts by weight of resin particle dispersion A in solid content conversion, 1400 parts by weight of ion-exchange water, 120 parts by weight of colorant particle dispersion Q and 3 parts by weight of polyoxyethylene-2-dodecylether sodium sulfate were dissolved in 120 parts by weight of ion-exchange water was charged in a reaction vessel fitted with a stirring device, a temperature sensor, a cooling tube and a nitrogen introducing device, and after the liquid temperature was set to 30° C., and pH was adjusted to 10 by adding an aqueous 5N sodium hydroxyide solution. Subsequently, an aqueous solution in which 35 parts by weight of magnesium chloride were dissolved in 35 parts by weight of ion-exchange water was added into the system at 30° C. for 10 minutes while stirring, and after standing for 3 minutes, the system was raised to 90° C. spending 60 minutes to continue the particle growth reaction keeping the temperature at 90° C. In this situation, the particle diameter of coagulated particles was measured with “Coulter Multisizer 3” (manufactured by Coulter Co., Ltd.), and when reaching the desired particle diameter, an aqueous solution in which 150 parts by weight of sodium chloride were dissolved in 600 parts by weight of ion-exchange water was added to terminate the particle growth. Further, inter-particle fusion was accelerated until reaching an average circularity of 0.965 via measurement employing “FPIA-2100” manufactured by Sysmex Corporation) by conducting a ripening step at a liquid temperature of 98° C. while stirring, and a hydrophilic resin was oriented onto the coagulated particle surface while a hydrophobic resin was oriented on the inner side of the coagulated particle to form toner particles having a core-shell structure. After the system was cooled down to 30° C., 8 parts by weight of a 0.7% by weight hydrochloric acid aqueous solution were added into 100 parts by weight of toner particles, and “colorant 1” firmly adhered onto the toner particle. Then, stirring was stopped.

The dispersion of toner particles subjected to hydrochloric acid treatment in the above-described process was solid/liquid-separated by a basket type centrifugal separator “Mark III type No. 60×40” manufactured by Matsumoto Kikai Mfg. Co. Ltd. to produce a toner particle wet cake. This wet cake was washed in ion-exchange water at 45° C. employing the foregoing basket type centrifugal separator until the separated liquid reached 5 μS/cm in electrical conductivity, and then moved to “Flash Jet Dryer” produced by Seishin Enterprise Co., Ltd. and dried until the moisture content reached 0.5% by weight to prepare “toner particle 1”.

Into this “toner particle 1”, 1% by weight of hydrophobic silica (a number average primary particle diameter of 12 nm) and 0.3% by weight of hydrophobic titania (a number average primary particle diameter of 20 nm) were added, and the system was mixed with a Henschel mixer to prepare “Toner 1”.

Incidentally, with respect to toner particle 1, no change in shape and particle diameter was obtained via addition of hydrophobic silica or hydrophobic titanium oxide.

### [Preparation of Toners 2-8]

“Toners 2-8” were prepared similarly to preparation of Toner 1, except that kinds of the releasing agent and the hydrochloric acid aqueous solution amount were replaced by those as shown in Table 1.

Table 1 shows the colorant kind, the hydrochloric acid aqueous solution amount and the colorant surface-exposure amount index of each toner prepared above.

TABLE 1

| | | | | | Hydro | |
|---|---|---|---|---|---|---|
| | | | | | chloric | |
| | | | | | acid | |
| | | | | | treat-ment | |
| | | | | | step | |
| | | | | | Amount | |
| | | | | | of | |
| | Colorant | | | | 0.7% by | |
| | Compound | | | | weight | |
| | represented by | | | | hydro- | |
| | Formula (1) | | Magenta colorant | | chloric | |
| | | Addi- | | Addi- | acid | |
| | | tion | | tion | aqueous | |
| | | amount | | amount | solution | |
| | | (parts | | (parts | (parts | |
| Toner | | by | | by | by | |
| No. | | weight) | | weight) | weight) | *1 |
| Toner 1 | Compound | 200 | Pigment | 200 | 15 | 0.3 |
| | (1) | | Red 48; 3 | | | |
| Toner 2 | Compound | 200 | Pigment | 200 | 13 | 0.5 |
| | (1) | | Red 48; 3 | | | |
| Toner 3 | Compound | 200 | Pigment | 200 | 10 | 0.8 |
| | (1) | | Red 48; 3 | | | |
| Toner 4 | Compound | 200 | Pigment | 200 | 13 | 0.5 |
| | (2) | | Red 48; 3 | | | |
| Toner 5 | Compound | 200 | Pigment | 200 | 13 | 0.6 |
| | (3) | | Red 48; 3 | | | |
| Toner 6 | Compound | 200 | Pigment | 200 | 6 | 1 |
| | (1) | | Red 48; 3 | | | |
| Toner 7 | Compound | 200 | Pigment | 200 | 25 | 0.15 |
| | (1) | | Red 48; 3 | | | |
| Toner 8 | — | — | Pigment | 400 | 13 | 0.1 |
| | | | Red 48; 3 | | | |

*1: Colorant suface-exposure amount index (absorbance at λ = 530 nm)

### [Preparation of Developers 1-8]

With respect to Toners 1-8, the silicone resin-coated ferrite carrier having a volume based average particle diameter of 60 μm was mixed so as to give a toner content of 6% by weight to prepare “Developers 1-8”.

### <<Evaluation>>

As an image forming apparatus for evaluation, “bizhub PRO C6500” manufactured by Konica Minolta Business Technologies, Inc. was arranged to be set.

The above-prepared toner and the developer were arranged to be set in the above-described image forming apparatus in order to conduct image formation at low temperature and low humidity (10° C. and 20% RH) employing transfer paper sheets “J paper” (a basic weight of 64 g/m²) produced by Konica Minolta Business Technologies, Inc.

Two thousand prints of images having a pixel ratio of 10% (original image with a text image having 6%, and a portrait image, a solid white image and a solid image each having 1) were made in a sheet-by-sheet intermittent mode with A4 size.

The following items were evaluated.

### (Charging Amount)

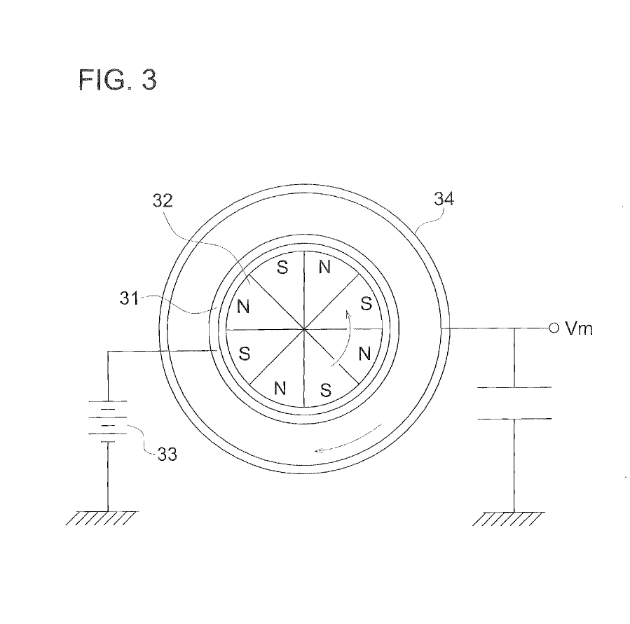

The charging amount of toner was measured at an initial stage of printing and after heavy-duty printing employing a charging amount measuring device shown in FIG. 3.

FIG. 3 shows a schematic diagram of a measuring device to measure the charging amount of toner.

In the figure, 31, 32, 33 and 34 are designated as a conductive sleeve, a magnet roll, a bias power supply and a cylindrical electrode, respectively.

One gram of toner weighed by a precision balance is first placed evenly on the entire surface of conductive sleeve 31. A voltage of 2 kV is supplied to sleeve 31 from bias power supply 33, and the rotation speed of magnet roll 32 installed in conductive sleeve 31 is set to 1000 rpm. After standing for 30 seconds in this situation, the toner is collected into cylindrical electrode 34. Voltage Vm of cylindrical electrode 34 is read out after 30 seconds to obtain the charging amount of toner, and the weight of the collected toner is further measured with a precision balance to determine the average charging amount.

In the present invention, a charging amount of toner of from −25.0 to −45.0 μC/g is accepted.

### (Image Density)

Through image densities at the initial stage of printing and after the heavy-duty printing, the density at a solid portion of the printed image was measured at 12 points employing a reflection densitometer RD-918, manufactured by Macbeth Co., Ltd., and was also evaluated. In addition, an image density of at least 1.20 is accepted.

### (Fog)

As for evaluation of fog of a printed image of toner at the initial stage of printing and after the heavy-duty printing, image density of not printed paper (white paper) was measured at 20 points, and the average value was designated as the white paper density. Next, the image density at the white image portion of printed paper of the blank image was measured similarly at 20 points, and the average density was calculated to evaluate the value obtained via subtraction of the white paper density from the average density as fog density. The foregoing measurement was done by a reflection densitometer RD-918, manufactured by Macbeth Co., Ltd. In addition, a fog of 0.006 or less is accepted.

### (Contamination Inside Apparatus)

Contamination inside an apparatus was evaluated and obtained from a visually observed contamination situation inside the apparatus caused by toner leakage and toner scattering around a developing device generated after printing 20000 prints, and contamination failure of a printed image caused by toner scattering. In the toner scattering evaluation, ranks A and B are accepted.

### Evaluation Criteria

A: Neither contamination inside an apparatus caused by toner leakage and toner scattering is observed, nor contamination failure of a printed image caused by toner scattering is observed.

B: Slight contamination inside an apparatus caused by toner leakage and toner scattering is observed, but no contamination failure of a printed image caused by toner scattering is observed (No problem produced in practical use).

C: Contamination inside an apparatus caused by toner leakage and toner scattering is largely observed, and contamination failure of a printed image caused by toner scattering is observed (Problem produced in practical use).

Evaluation results are shown in Table 2.

TABLE 2

| | | At initial stage | | | | | | |
|---|---|---|---|---|---|---|---|---|
| | | of printing | | | After heavy-duty printing | | | |
| | Toner | | Image | | | Image | | |
| | No. | *1 | density | Fog | *1 | density | Fog | *2 |
| Ex. 1 | Toner 1 | −32 | 1.38 | 0.002 | −28 | 1.43 | 0.005 | B |
| Ex. 2 | Toner 2 | −35 | 1.35 | 0.001 | −33 | 1.35 | 0.001 | A |
| Ex. 3 | Toner 3 | −42 | 1.25 | 0.001 | −44 | 1.21 | 0.001 | A |
| Ex. 4 | Toner 4 | −35 | 1.35 | 0.001 | −35 | 1.34 | 0.002 | A |
| Ex. 5 | Toner 5 | −30 | 1.41 | 0.002 | −28 | 1.4 | 0.006 | B |
| Comp. 1 | Toner 6 | −45 | 1.21 | 0.001 | −52 | 1.1 | 0.002 | A |
| Comp. 2 | Toner 7 | −30 | 1.41 | 0.005 | −22 | 1.43 | 0.021 | C |
| Comp. 3 | Toner 8 | −30 | 1.42 | 0.006 | −23 | 1.43 | 0.032 | C |

*1: Charging amount (μC/g)
*2: Contamination inside apparatus
Ex: Present example
Comp.: Comparative example

As is clear from Table 2, it is to be understood that as to image formation of each of “Examples 1-5” conducted with the toner of the present invention, the evaluated results concerning change in charging amount, image density, fog and toner scattering have produced no problem at all.

In contrast, it is also to be understood that as to image formation of each of “Comparative examples 1-3” conducted with the toner of the comparative example, any of the above-described evaluation items has caused a problem, and the objective of the present invention has not been achieved.

### [Effect of the Invention]

An electrophotographic toner of the present invention (hereinafter, also referred to simply as toner) and a method of manufacturing the toner produce excellent effects such that a charging amount of toner is kept maintaining to be an appropriate value for a long duration, print images with no fog, together with high density obtained even after heavy-duty printing are obtained, and no contamination within an apparatus caused by toner scattering is generated.

What is claimed is:

1. An electrophotographic toner comprising a resin and a colorant,
wherein the colorant comprises a compound represented by Formula (1) or a lake product of the compound, and
the colorant extracted from the electrophotographic toner surface has a colorant surface-exposure amount index of 0.3-0.8: 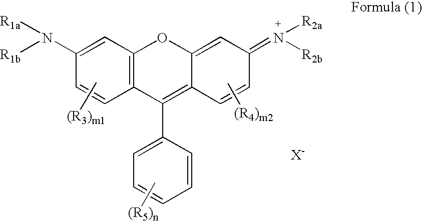
wherein each of R₁ₐ, R_{1b}, R₂ₐ and R_{2b} represents a hydrogen atom, an alkyl group having 1-5 carbon atoms, a fluoroalkyl group having 1-5 carbon atoms or an aryl group; each of R₃ and R₄ represents an alkyl group having 1-5 carbon atoms or a fluoroalkyl group having 1-5 carbon atoms; R₅ represents an alkyl group having 1-5 carbon atoms, a fluoroalkyl group having 1-5 carbon atoms, an alkoxyl group having 1-5 carbon atoms, a halogen atom, a cyano group, a nitro group, a sulfo group, an alkaline earth metal salt of a sulfo group, a higher amine salt of a sulfo group, an N-phenylaminosulfonyl group, a carboxyl group, an alkaline earth metal salt of a carboxyl group, a higher amine salt of a carboxyl group, an N-phenylcarbamoyl group, a ureylene group, an iminodicarbonyl group, an alkoxycarbonyl group, —CONHR₆ where R₆ represents a hydrogen atom, an alkyl group having 1-8 carbon atoms or a phenyl group having 1-8 carbon atoms, —NHCOR₇ where R₇ represents an alkyl group, or —SO₂R₈ where R₈ represents an alkyl group having 1-8 carbon atoms; each of m1 and m2 represents an integer of 1-3; n is an integer of 1-5; and X⁻ represents an anion.

2. The electrophotographic toner of claim 1,
wherein the electrophotographic toner is a two-component developer.

3. The electrophotographic toner of claim 1,
wherein the compound represented by Formula (1) has a content of 30-100% by weight, based on the total weight of the colorant.

4. The electrophotographic toner of claim 3,
wherein the compound has a content of 40-80% by weight, based on the total weight of the colorant.

5. A method of manufacturing an electrophotographic toner composed of toner particles each comprising a resin and a colorant, comprising the steps of:
forming the toner particles via a polymerization method; and
diluting 0.056-0.14 parts of a hydrochloric acid with water with respect to 100 parts of the toner particles to conduct a treatment via addition of the hydrochloric acid aqueous solution,
wherein the colorant comprises a compound represented by Formula (1) or a lake product of the compound: 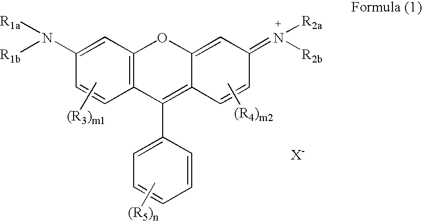
wherein each of R₁ₐ, R_{1b}, R₂ₐ and R_{2b} represents a hydrogen atom, an alkyl group having 1-5 carbon atoms, a fluoroalkyl group having 1-5 carbon atoms or an aryl group; each of R₃ and R₄ represents an alkyl group having 1-5 carbon atoms or a fluoroalkyl group having 1-5 carbon atoms; R₅ represents an alkyl group having 1-5 carbon atoms, a fluoroalkyl group having 1-5 carbon atoms, an alkoxyl group having 1-5 carbon atoms, a halogen atom, a cyano group, a nitro group, a sulfo group, an alkaline earth metal salt of a sulfo group, a higher amine salt of a sulfo group, an N-phenylaminosulfonyl group, a carboxyl group, an alkaline earth metal salt of a carboxyl group, a higher amine salt of a carboxyl group, an N-phenylcarbamoyl group, a ureylene group, an iminodicarbonyl group, an alkoxycarbonyl group, —CONHR₆ where R₆ represents a hydrogen atom, an alkyl group having 1-8 carbon atoms or a phenyl group having 1-8 carbon atoms, —NHCOR₇ where R₇ represents an alkyl group, or —SO₂R₈ where R₈ represents an alkyl group having 1-8 carbon atoms; each of m1 and m2 represents an integer of 1-3; n is an integer of 1-5; and X⁻ represents an anion.

6. The method of claim 5,
wherein the compound represented by Formula (1) has a content of 30-100% by weight, based on the total weight of the colorant.

7. The method of claim 6,
wherein the compound represented by Formula (1) has a content of 30-100% by weight, based on the total weight of the colorant.
